(19) United States
(12) Patent Application Publication
(10) Pub. No.: US 2017/0171277 A1
(43) Pub. Date: Jun. 15, 2017

(54) Method and electronic device for multimedia recommendation based on android platform

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Xuehui SHI, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/238,202

(22) Filed: Aug. 16, 2016

Related U.S. Application Data
(63) Continuation of application No. PCT/CN2016/089705, filed on Jul. 11, 2016.

(30) Foreign Application Priority Data
Dec. 11, 2015 (CN) 2015109212166

(51) Int. Cl. H04L 29/06; H04N 21/4402; H04N 21/435; H04N 21/25

(52) U.S. Cl. CPC H04L 65/604; H04L 67/42; H04N 21/251; H04N 21/4402; H04N 21/435; H04W 88/02

(57) ABSTRACT

A method, and an electronic device based on an Android platform for multimedia recommendation are provided. The method includes: sending a multimedia recommendation request to a server; acquiring a multimedia recommendation page and at least one low-resolution multimedia resource in response to the multimedia recommendation request; and embedding the low-resolution multimedia resource in a corresponding preview position in the multimedia recommendation page.

### CROSS REFERENCE TO RELATED APPLICATIONS

The present application is a continuation of PCT application No. PCT/CN2016/089705 submitted on Jul. 11, 2016, and claims priority to Chinese Patent Application No. 201510921216.6, filed with the Chinese Patent Office on Dec. 11, 2015, both of which are incorporated herein by reference in their entireties.

### TECHNICAL FIELD

This disclosure relates to the field of computer technologies, and in particular, to a method and an electronic device based on an Android platform for multimedia recommendation.

### BACKGROUND

Nowadays, a video play application (for example, LeTV, iQIYI, or StormPlayer, etc.) is usually provided on a terminal device for an Android system. After clicking on the video play application, a user enters a video recommendation page. The video recommendation page mostly includes many video posters or static pages of amazing videos. If intending to watch a video, the user needs to click a static page of a video to enter a video play page to learn detailed video content in addition to the static page.

### SUMMARY

The present disclosure is to provide a method and an electronic device based on an Android platform for multimedia recommendation, to improve viewing experience of a user.

According to a first aspect, an embodiment of the present disclosure provides a multimedia recommendation method based on an Android platform applied to a terminal device installed with an Android platform, where the method includes: sending a multimedia recommendation request to a server; acquiring a multimedia recommendation page and at least one low-resolution multimedia resource in response to the multimedia recommendation request; and embedding the low-resolution multimedia resource in a corresponding preview position in the multimedia recommendation page.

According to a second aspect, an embodiment of the present disclosure further provides a non-transitory computer storage medium, which stores executable instructions, where the executable instructions are used to execute any of the foregoing multimedia recommendation method based on Android platform of the present disclosure.

According to a third aspect, an embodiment of the present disclosure further provides an electronic device, including: at least one processor; and a memory in communication connection with the at least one processor. The memory stores instructions that can be executed by the at least one processor, so that the at least one processor can execute any of the foregoing multimedia recommendation method based on Android platform of the present disclosure.

According to a fourth aspect, an embodiment of the present disclosure further provides a multimedia recommendation method based on an Android platform which includes: parsing a multimedia recommendation request, and acquiring information of a recommended multimedia resource and an address of a corresponding low-resolution multimedia resource; generating a multimedia recommendation page according to the information of the recommended multimedia resource; and sending the multimedia recommendation page and the address of the low-resolution multimedia resource to a terminal device.

The method and the electronic device based on an Android platform for multimedia recommendation provided in the embodiments of the present disclosure, embedding a corresponding low-resolution multimedia resource in a preview position in a recommendation page presented to a user, so as to recommend a multimedia resource to the user, and improve viewing experience of the user at the same time.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a flowchart of a multimedia recommendation method based on an Android platform provided by Embodiment 1 of the present disclosure;

FIG. 2 is a flowchart of a multimedia recommendation method based on an Android platform provided by Embodiment 2 of the present disclosure;

FIG. 3 is a schematic structural diagram of a terminal device based on an Android platform provided by Embodiment 3 of the present disclosure; and

FIG. 4 is a schematic structural diagram of a terminal device based on an Android platform provided by Embodiment 4 of the present disclosure;

FIG. 5 is a schematic structural diagram of hardware of a device for executing a multimedia recommendation method provided by Embodiment 6 of the present disclosure.

FIG. 6 is a schematic structural diagram of hardware of a server provided by Embodiment 6 of the present disclosure.

### DETAILED DESCRIPTION

To make the objectives, technical solutions, and advantages of the present disclosure clearer, hereinafter, the technical solutions of the present disclosure will be clearly and completely described by implementation manners with reference to the accompanying drawings in the embodiments of the present disclosure. Apparently, the described embodiments are a part rather than all of the embodiments of the present disclosure.

### Embodiment 1

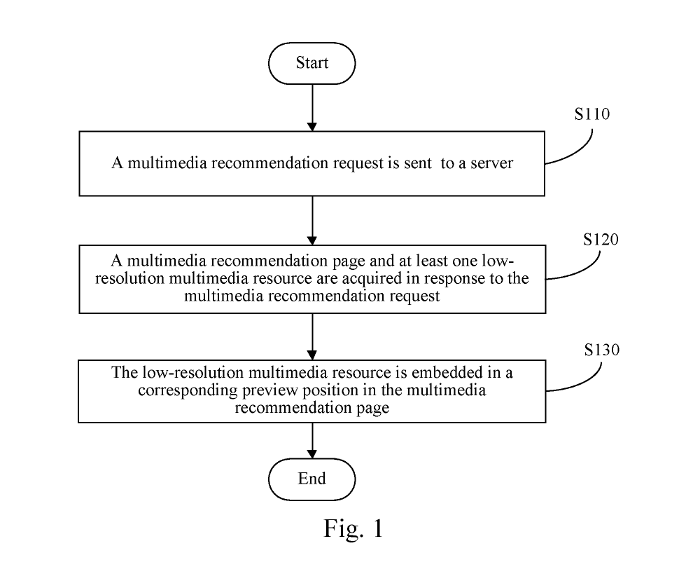

FIG. 1 is a flowchart showing a multimedia recommendation method based on an Android platform according to Embodiment 1 of the present disclosure.

Referring to FIG. 1, the multimedia recommendation method based on an Android platform includes the following steps:

In Step S110: a multimedia recommendation request is sent to a server.

Specifically, an execution body of the method is a terminal device provided with an Android system, which includes, but is not limited to, a mobile phone, a tablet, or a smart TV, etc. Optionally, the server may be a video server, and is used to provide multimedia resources, multimedia resource information, and the like to the terminal device. In this embodiment, optionally, the multimedia resources are videos.

In this embodiment, after a user enters a video APP application by using a mobile phone or a tablet, the application program proactively sends a video recommendation request to the server. Optionally, these videos may be classified according to different types as films, TV series, anime, games, or the like.

In step S120: a multimedia recommendation page and at least one low-resolution multimedia resource are acquired in response to the multimedia recommendation request.

In this embodiment, a method for the terminal device to acquire a multimedia recommendation page and at least one low-resolution multimedia resource may include, but is not limited to:

In an embodiment, the server parses the multimedia recommendation request, and acquires information of a recommended multimedia resource and an address of a corresponding low-resolution multimedia resource. The server may be a video server. The server receives the multimedia recommendation request; searches locally, according to the multimedia recommendation request, information of a corresponding recommended multimedia resource and an address of a low-resolution multimedia resource corresponding to the information of the recommended multimedia resource. For example, the information of the recommended multimedia resource may be a poster for Nirvana in Fire, a poster for Legend of Miyue, and/or a poster for Dragon Ball, etc., and then the address of the corresponding low-resolution multimedia resource is searched according to the information of the recommended multimedia resource, for example, a download address of a low-resolution multimedia resource corresponding to Nirvana in Fire: http://www.12356.com, etc.

The server generates a multimedia recommendation page according to the information of the recommended multimedia resource. The server allows the information of the recommended multimedia resource and corresponding position information in the presentation page of the information of the recommended multimedia resource to be carried in the multimedia recommendation page.

The server sends the multimedia recommendation page and the address of the low-resolution multimedia resource to the terminal device.

The terminal device downloads the corresponding low-resolution multimedia resource according to the address of the low-resolution multimedia resource. The terminal device creates a thread and calls the thread to download the corresponding low-resolution multimedia resource according to the address of the low-resolution multimedia resource.

Specifically, in this embodiment, the multimedia recommendation page may include, but is not limited to, posters or presentation pages for amazing videos of videos in a video library provided by the video application to the user, where a video is usually presented in a form of a picture or a text. For example, the video recommendation page includes numerous video pictures, where a directory of TV series includes, for example, Nirvana in Fire, Legend of Zhen Huan, or Romance of the Three Kingdoms, etc.; a directory of anime includes Naruto, Bleach, Fist of the North Star, or One Piece, etc.; and a directory of game includes Dungeon & Fighter, League of Legends, or Cross Fire, etc.

Specifically, each video provider has a different definition for low resolution, and a resolution is relevant to mobile phone performance and a network speed. Therefore, only a range is given in this embodiment. For example, a resolution of a low-resolution multimedia resource falls within the following range: (480±N) pixels*(240±M) pixels, where N is not less than 0 and not greater than 100 and M is not less than 0 and not greater than 100.

In an implementation manner, the low-resolution video content information may be a video in the foregoing video recommendation page, and also may be a video other than the videos included in the page.

Optionally, the terminal device may also synchronously acquire content information of multiple low-resolution videos, for example, content information of low-resolution videos of Nirvana in Fire, One Piece, and Dungeon & Fighter.

In step S130: the low-resolution multimedia resource is embedded in a corresponding preview position in the multimedia recommendation page.

The terminal device sets a canvas in a preview position. The canvas is used to display information of the multimedia resource, for example, displaying a poster for a recommended multimedia resource and the like in a corresponding preview position in the multimedia recommendation page.

In addition, the terminal device creates a play window corresponding to the preview position. The play window is used to start playing the low-resolution multimedia resource after the canvas in the corresponding preview position is removed.

Specifically, the foregoing preview position may be a position in the upper left corner, the lower left corner, the upper right corner, the lower right corner, or the middle of the video recommendation page. After a mobile phone receives the video recommendation page and the content information of at least one low-resolution video from the server, the mobile phone will embed the low-resolution video content in the foregoing preview position.

Preferably, an area in the preview position cannot be so large as to affect a user to view other video recommendation information, nor can the area be so small that the low-resolution video is more blurred and unclear to see. Preferably, the specific location and size of the preview position may also be set according to difference of a mobile phone or a tablet.

The multimedia recommendation method based on an Android platform provided in this embodiment of the present disclosure, embeds a corresponding low-resolution multimedia resource in a preview position in a recommendation page presented to a user, so as to recommend a multimedia resource to the user, and improve viewing experience of the user at the same time.

### Embodiment 2

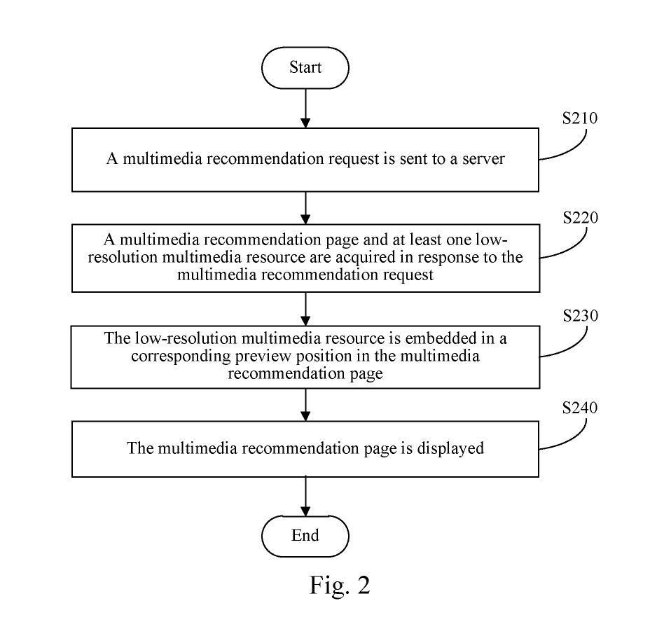

FIG. 2 is a flowchart showing a multimedia recommendation method based on an Android platform according to Embodiment 2 of the present disclosure.

Referring to FIG. 2, the multimedia recommendation method based on an Android platform includes the following steps:

In step S210: a multimedia recommendation request is sent to a server.

In step S220: a multimedia recommendation page and at least one low-resolution multimedia resource are acquired in response to the multimedia recommendation request.

In step S230: the low-resolution multimedia resource is embedded in a corresponding preview position in the multimedia recommendation page.

Contents of step S210, step S220, and step S230 respectively correspond to those of step S110, step S120, and step S130 of the forgoing Embodiment 1, and their functions and principles are the same, which are not described herein again.

Based on the foregoing steps, the multimedia recommendation method based on an Android platform in this embodiment further includes step S240 and step S250.

In step S240: the multimedia recommendation page is displayed.

When the user drags the multimedia recommendation page so that some preview positions are in a focus area, the terminal device acquires information of a first preview position in a preset focus area in the multimedia recommendation page. The information of the first preview position may include, but is not limited to, coordinates of the first preview position, and the like.

A canvas in the first preview position is removed according to the information of the first preview position.

A play window corresponding to the first preview position is called to start playing the low-resolution multimedia resource. After the canvas in the first preview position is removed, the terminal device starts playing, by the created play window, a decoded part of the low-resolution multimedia resource corresponding to the first preview position. When there are multiple first preview positions, multiple canvases may be removed at the same time, and the corresponding low-resolution multimedia resources are started playing at the same time by different play windows respectively.

Specifically, after receiving the video recommendation page and the at least one low-resolution video resource from the server, the terminal device displays the video recommendation page, where the page includes the foregoing low-resolution video resource. Preferably, multiple video clips may be displayed at the same time on the video recommendation page, for example, a clip of Three Visits to the Hutby Liubei, a clip of Wu Song Fights the Tiger, or a clip of Sun Wu kong Fights Red Boy. Preferably, a video clip may be selectively displayed on the video recommendation page according to scrolling of a scroll wheel of a mouse by a user. For example, when the user starts entering the page, a video clip of Romance of the Three Kingdoms is displayed, and when the mouse is scrolled to a next position, a video clip of Water Margin is displayed on the page. Preferably, a corresponding video may also be displayed on the video recommendation page according to a poster or a video frame of a amazing video touched by a mouse of the user. For example, when the mouse touches a poster for One Piece, a video clip of One Piece is displayed on the page, and when the mouse touches a poster for Naruto, a video clip of Naruto is displayed on the page.

Specifically, the preset focus area is in a central position of a screen of the terminal device.

For example, after a user accesses video application software LeTV by using a mobile phone, a video recommendation page displayed by the software is provided with a video play function. Assuming that the video recommendation page includes posters for Nirvana in Fire and One Piece, a low-resolution amazing video of an episode of Nirvana in Fire and/or One Piece is played in a central position of the mobile phone on the video recommendation page. If the user dislikes Nirvana in Fire, the user does not need to enter a video play page of Nirvana in Fire to learn about it, which avoids unnecessary operations of the user, improves experience, and reduces traffic at the same time.

Optionally, the low-resolution multimedia resource is a clip of a corresponding multimedia resource or a trailer of the corresponding multimedia resource, where the trailer includes a amazing video, an opening, or an ending. For example, a low-resolution video clip or video trailer of Romance of the Three Kingdoms may be a clip of Oath of Brotherhood in the Peach Garden, a clip of Three Heros Fight Lv Buat Hu Lao Gate, an opening video with the song Rolling Yangtze River Flows East, an ending video with the song The Sky in the History, or the like.

The multimedia recommendation method based on an Android platform provided in this embodiment of the present disclosure, plays a corresponding low-resolution multimedia resource in a preview position in a recommendation page presented to a user, and before selecting a to-be-played resource, the user may learn video content better by the previewed low-resolution multimedia resource, to select more intuitively the to-be-played resource, which makes operations of the user more simple and convenient and improves user experience.

### Embodiment 3

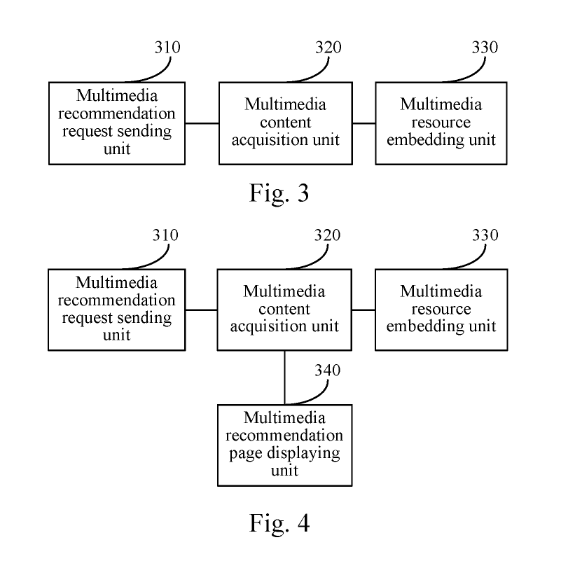

FIG. 3 is a schematic structural diagram showing a terminal apparatus based on an Android platform according to Embodiment 3 of the present disclosure.

Referring to FIG. 3, the terminal apparatus based on an Android platform in this embodiment is used to execute the steps in the method in FIG. 1, and the apparatus includes: a multimedia recommendation request sending unit 310, a multimedia content acquisition unit 320, and a multimedia resource embedding unit 330.

The multimedia recommendation request sending unit 310 sends a multimedia recommendation request to a server.

The multimedia content acquisition unit 320 acquires a multimedia recommendation page and at least one low-resolution multimedia resource in response to the multimedia recommendation request sent by the multimedia recommendation request sending unit 310.

In an embodiment, the server parses the multimedia recommendation request, and acquires information of a recommended multimedia resource and an address of a corresponding low-resolution multimedia resource. The server generates a multimedia recommendation page according to the information of the recommended multimedia resource. The server sends the multimedia recommendation page and the address of the low-resolution multimedia resource to the terminal apparatus. The multimedia content acquisition unit further downloads the corresponding low-resolution multimedia resource according to the address of the low-resolution multimedia resource.

The multimedia resource embedding unit 330 embeds the low-resolution multimedia resource, acquired by the multimedia content acquisition unit 320, in a corresponding preview position in the multimedia recommendation page.

Optionally, a canvas is set in the preview position, and the canvas is used to display information of the multimedia resource, where the multimedia resource embedding unit further creates a play window corresponding to the preview position, and the play window is used to play the low-resolution multimedia resource.

The terminal apparatus based on an Android platform provided in this embodiment of the present disclosure, embeds a corresponding low-resolution multimedia resource in a preview position in a recommendation page presented to a user, so as to recommend a multimedia resource to the user, and improve viewing experience of the user at the same time.

### Embodiment 4

FIG. 4 is a schematic structural diagram showing a terminal apparatus based on an Android platform according to Embodiment 4 of the present application.

Referring to FIG. 4, the terminal apparatus based on an Android platform in this embodiment is used to execute the steps in the method in FIG. 2, and the apparatus includes: a multimedia recommendation request sending unit 310, a multimedia content acquisition unit 320, a multimedia resource embedding unit 330, a multimedia recommendation page displaying unit 340, and a multimedia resource playing unit 350.

The multimedia recommendation request sending unit 310 sends a multimedia recommendation request to a server.

The multimedia content acquisition unit 320 acquires a multimedia recommendation page and at least one low-resolution multimedia resource in response to the multimedia recommendation request sent by the multimedia recommendation request sending unit 310.

The multimedia resource embedding unit 330 embeds the low-resolution multimedia resource, acquired by the multimedia content acquisition unit 320, in a corresponding preview position in the multimedia recommendation page.

The multimedia recommendation page displaying unit 340 displays the multimedia recommendation page acquired by the multimedia content acquisition unit 320.

In an implementation manner, the multimedia recommendation page displaying unit includes:

a focus acquisition subunit (not shown in the figure), the focus acquisition subunit acquires information of a first preview position in a preset focus area in the multimedia recommendation page.

A canvas processing subunit (not shown in the figure), the canvas processing subunit removes a canvas in the first preview position according to the information of the first preview position.

A play subunit (not shown in the figure), the play subunit calls a play window corresponding to the first preview position to start playing the low-resolution multimedia resource.

Preferably, the low-resolution multimedia resource is a clip of a corresponding multimedia resource or a trailer of the corresponding multimedia resource.

The terminal apparatus based on an Android platform provided in this embodiment of the present disclosure, plays a corresponding low-resolution multimedia resource in a preview position in a recommendation page presented to a user, and before selecting a to-be-played resource, the user may learn video content better by the previewed low-resolution multimedia resource, to select more intuitively the to-be-played resource, which makes operations of the user more simple and convenient and improves user experience.

It is to be noted that, according to requirements of implementation, various step/component described in this application may be divided into more steps/components, and two or more steps/components or some operations of step/component may also be combined into a new step/component to implement the objective of the present disclosure.

The foregoing method according to the present disclosure may be implemented in hardware or firmware, or may be implemented as software or computer code that may be stored in a recording medium (such as a CD ROM, a RAM, a floppy disk, a hard disk, or a magneto-optical disk), or may be implemented as computer code downloaded from a network that is originally stored in a remote recording medium or non-transitory machine readable medium and to be stored in a local recording medium. Therefore, the method described herein may be processed by such software stored in a recording medium that uses a general-purpose computer, a special-purpose processor, or programmable or special-purpose hardware (such as an ASIC or an FPGA). It can be understood that, a computer, a processor, a microprocessor controller, or programmable hardware includes a storage component (for example, a RAM, a ROM, or a flash disk, etc.) that can store or receive software or computer code. When the software or computer code is accessed and executed by the computer, the processor, or the hardware, the processing method described herein is implemented. In addition, when the general computer accesses the code for implementing processing described herein, execution of the code converts the general-purpose computer into a special-purpose computer for performing the processing described herein.

### Embodiment 5

Embodiment 5 of the application provides a non-transitory computer storage medium, which stores executable instructions, where the executable instructions can execute the multimedia recommendation method based on Android platform of any of foregoing method embodiments of the application.

### Embodiment 6

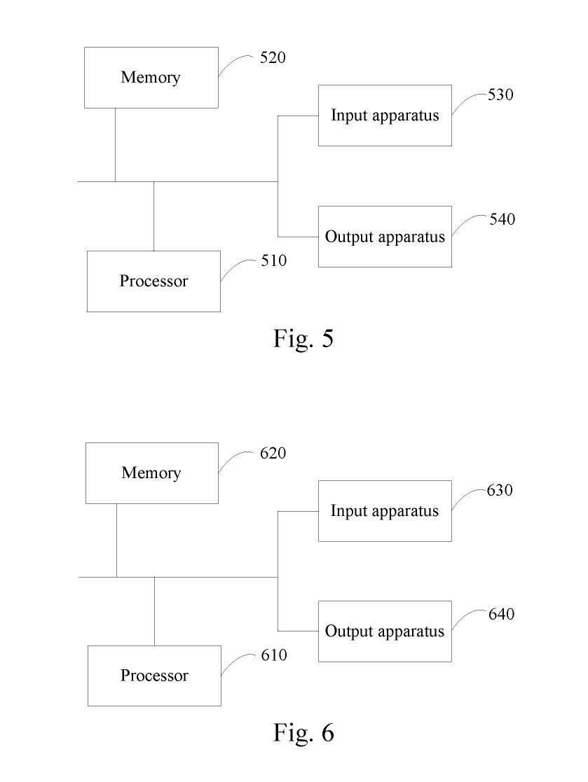

FIG. 5 is a schematic structural diagram of hardware of an electronic device for executing a multimedia recommendation method based on Android platform provided by Embodiment 6 of the present disclosure. As shown in FIG. 5, the device includes:

one or more processors 510 and a memory 520, with one processor 510 as an example in FIG. 5.

A device for executing the multimedia recommendation method based on Android platform may further include: an input apparatus 530 and an output apparatus 540.

The processor 510, the memory 520, the input apparatus 530, and the output apparatus 540 can be connected by means of a bus or in other manners, with a connection by means of a bus as an example in FIG. 5.

As a non-transitory computer readable storage medium, the memory 520 can be used to store non-transitory software programs, non-transitory computer executable programs and modules, for example, program instructions/module corresponding to the multimedia recommendation method based on Android platform in the embodiments of the application. The processor 510 executes various functional applications and data processing of the server, that is, implements the multimedia recommendation method based on Android platform of the foregoing method embodiments, by running the non-transitory software programs, instructions, and modules stored in the memory 520.

The memory 520 may include a program storage area and a data storage area, where the program storage area may store an operating system and at least one application needed by function; the data storage area may store data created according to use of a device for multimedia recommendation, and the like. In addition, the memory 520 may include a high-speed random access memory, and also may include a non-transitory memory, such as at least one disk storage device, flash storage device, or other non-transitory solid-state storage devices. In some embodiments, the memory 520 optionally includes memories remotely disposed with respect to the processor 510, and the remote memories may be connected, via a network, to the device for multimedia recommendation. Examples of the foregoing network include but are not limited to: the Internet, an intranet, a local area network, a mobile communications network, and a combination thereof.

The input apparatus 530 can receive entered digit or character information, and generate key signal inputs relevant to user setting and functional control of the device for multimedia recommendation. The output apparatus 540 may include a display device, for example, a display screen, etc.

The one or more modules are stored in the memory 520,and execute the multimedia recommendation method based on Android platform in any one of the foregoing method embodiments when being executed by the one or more processors 510.

The foregoing product can execute the method provided in the embodiments of the application, and has corresponding functional modules for executing the method and beneficial effects. The method provided in the embodiments of the application can be referred to for technical details that are not described in detail in the embodiment.

The electronic device in the embodiment of the application exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the application, rather than limiting thereon. Although the application has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the application.

1. A multimedia recommendation method based on an Android platform, applied to an electronic device, wherein the method comprises:
sending a multimedia recommendation request to a server;
acquiring a multimedia recommendation page and at least one low-resolution multimedia resource in response to the multimedia recommendation request; and
embedding the low-resolution multimedia resource in a corresponding preview position in the multimedia recommendation page.

2. The method according to claim 1, wherein the acquiring a multimedia recommendation page and at least one low-resolution multimedia resource comprises:
receiving the multimedia recommendation page and an address of the low-resolution multimedia resource that are sent by the server, and downloading the corresponding low-resolution multimedia resource according to the address of the low-resolution multimedia resource.

3. The method according to claim 1, wherein a canvas is set in the preview position, and the canvas is used to display information of the multimedia resource, wherein the embedding the low-resolution multimedia resource in a corresponding preview position in the multimedia recommendation page comprises:
creating a play window corresponding to the preview position, wherein the play window is used to play the low-resolution multimedia resource.

4. The method according to claim 3, wherein the method further comprises:
displaying the multimedia recommendation page.

5. The method according to claim 4, wherein the displaying the multimedia recommendation page comprises:
acquiring information of a first preview position in a preset focus area in the multimedia recommendation page;
removing the canvas in the first preview position according to the information of the first preview position; and
calling a play window corresponding to the first preview position to start playing the low-resolution multimedia resource.

6. A non-transitory computer storage medium storing executable instructions that, when executed by an electronic device, cause the electronic device to:
send a multimedia recommendation request to a server;
acquire a multimedia recommendation page and at least one low-resolution multimedia resource in response to the multimedia recommendation and
embed the low-resolution multimedia resource in a corresponding preview position in the multimedia recommendation page.

7. (canceled)

8. The non-transitory computer storage medium according to claim 6, wherein the instructions to acquire a multimedia recommendation page and at least one low-resolution multimedia resource cause the electronic device to: receive the multimedia recommendation page and an address of the low-resolution multimedia resource that are sent by the server, and download the corresponding low-resolution multimedia resource according to the address of the low-resolution multimedia resource.

9. The non-transitory computer storage medium according to claim 6, wherein a canvas is set in the preview position, and the canvas is used to display information of the multimedia resource, wherein the instructions to embed the low-resolution multimedia resource in a corresponding preview position in the multimedia recommendation page cause the electronic device to:
create a play window corresponding to the preview position, wherein the play window is used to play the low-resolution multimedia resource.

10. The non-transitory computer storage medium according to claim 9, wherein the electronic device is further caused to:
display the multimedia recommendation page.

11. The non-transitory computer storage medium according to claim 10, wherein the instructions to display the multimedia recommendation page cause the electronic device to:
acquire information of a first preview position in a preset focus area in the multimedia recommendation page;
remove a canvas in the first preview position according to the information of the first preview position; and
call a play window corresponding to the first preview position to start playing the low-resolution multimedia resource.

12. The electronic device according to claim 13, wherein the execution of the instructions to acquire a multimedia recommendation page and at least one low-resolution multimedia resource causes the at least one processor to:
receive the multimedia recommendation page and the address of the low-resolution multimedia resource sent by the server; and download a corresponding low-resolution multimedia resource according to the address of the low-resolution multimedia resource.

13. An electronic device, comprising:
at least one processor; and
a memory in communication connection with the at least one processor and for storing instructions executable by the at least one processor, wherein execution of the instructions by the at least one processor causes the at least one processor to:
send a multimedia recommendation request to a server;
acquire a multimedia recommendation page and at least one low-resolution multimedia resource in response to the multimedia recommendation request; and
embed the low-resolution multimedia resource in a corresponding preview position in the multimedia recommendation page.

13. The electronic device according to claim 12, wherein a canvas is set in the preview position, and the canvas is used to display information of the multimedia resource, wherein the execution of the instructions to embed the low-resolution multimedia resource in a corresponding preview position in the multimedia recommendation page causes the at least one processor to:
create a play window corresponding to the preview position, wherein the play window is used to play the low-resolution multimedia resource.

14. The electronic device according to claim 13, wherein the at least one processor is further caused to:
display the multimedia recommendation page.

15. The electronic device according to claim 14, wherein the execution of the instructions to display the multimedia recommendation page causes the at least one processor to:
acquire information of a first preview position in a preset focus area in the multimedia recommendation page;
remove a canvas in the first preview position according to the information of the first preview position; and
call a play window corresponding to the first preview position to start playing the low-resolution multimedia resource.
